(19) United States
(12) Patent Application Publication
(10) Pub. No.: US 2015/0113009 A1
(43) Pub. Date: Apr. 23, 2015

(54) METHOD AND DEVICE FOR PROCESSING FILE HAVING UNKNOWN FORMAT

(71) Applicant: TENCENT TECHNOLOGY (SHENZHEN) COMPANY LIMITED, Shenzhen City, Guangdong Province (CN)

(72) Inventors: Peng Zhou, Shenzhen (CN); Baojian Wang, Shenzhen (CN)

(73) Assignee: TENCENT TECHNOLOGY (SHENZHEN) COMPANY LIMITED, Shenzhen City, Guangdong Province (CN)

(21) Appl. No.: 14/407,986

(22) PCT Filed: Jun. 7, 2013
(86) PCT No.: PCT/CN2013/076899

§ 371 Date: Dec. 15, 2014

(30) Foreign Application Priority Data
Jun. 14, 2012 (CN) 201210195762.2

(51) Int. Cl. G06F 17/30

(52) U.S. Cl. CPC G06F 17/30076; G06F 17/30106
USPC 707/755

(57) ABSTRACT

Provided in an example of the present disclosure are a method and apparatus for processing a file having an unknown format, the method comprising: parsing the file header of the file having an unknown format so as to acquire a file format keyword from the file header; determining the file format type of the file having an unknown format, based on the file format keyword, and acquiring an application associated with the unknown file having the format according to the file format type. After the method in the example of the present disclosure is applied, the software environment required for opening this type of file can be determined based on file header analysis, thus avoiding the situation of file format being misjudged in the prior art because the file format and the associated program are determined on the basis of the suffix, thus improving the matching success rate of the associated program.

This present disclosure claims priority of Chinese patent application No. 201210195762.2 entitled “Method and device for processing file having unknown format” and filed on Jun. 14, 2012 with the Patent Office of the People's Republic of China, the disclosure of which is incorporated by reference.

### FIELD

Various examples of the present disclosure relates to computer applications, and more particularly, to a method and an apparatus of processing files in unknown formats.

### BACKGROUND

With rapid development of the computer technology and the Internet, people interact with each other more and more frequently. There are various types of applications available for various functions, e.g., instant messaging, audio/video playing, resource downloading, Web browsing, inputting, system auxiliary functions, etc.

An important function of application software is to process data. Different types of data are generated by the increasing types of software. Data is usually arranged in a certain format. The increasing typed of data has increasing number of data formats, and the various formats are too many for most users to memorize.

The demand for arranging data file identities emerged when the disk operating system (DOS) was used before the era of the Windows operating systems. At that time, there were only a few types of software and data formats, so DOS adopted a simple method in which file names were made up of a full name of a file and a suffix (i.e., an 8+3 manner). It was easy for users to memorize, and in the meantime it was also easy to be analyzed and processed by software. Along with evolvement of the windows operating systems, the amount of file formats increase sharply, but the method for processing files has stayed much the same with minor technical modifications. For example, the restriction of the number of characters in a file name has been removed. Those minor modifications cannot meet the growing demand for file types and formats. A file cannot be opened by an operating system using software installed in a computer if there is no software associated with the format of the file in a computer.

The format of a file and associated software are conventionally determined mainly on the basis of the suffix of the file. However, the mere file suffix can provide limited amount of information and the same suffix may be associated with multiple software programs. Therefore, file formats are highly likely to be incorrectly identified, and the rate of correctly identifying software programs associated with file formats is not satisfying. Further, since a file suffix can easily be maliciously tampered to be confused with other file formats, an appropriate software program associated with a file is difficult to be identified.

### SUMMARY

Various examples provide a method for processing files in unknown formats to improve the rate of correctly identifying software programs associated with files.

Various examples also provide an apparatus for processing files in unknown formats to improve the rate of correctly identifying software programs associated with files.

Technical mechanisms of various examples are as follows.

A method for processing files in unknown formats may include:

parsing a file header of a file in an unknown format to acquire a file format keyword from the file header; and

determining a file format type of the file based on the file format keyword, and acquiring an application associated with the file according to the file format type.

An apparatus for processing files in unknown formats may include a file header parsing unit and an application identifying unit.

The file header parsing unit is configured for parsing a file header of a file in an unknown format to acquire a file format keyword from the file header.

The application identifying unit is configured for determining a file format type of the file based on the file format keyword, and acquiring an application associated with the file according to the file format type.

A method for processing files in unknown formats may include:

pre-setting a table of relations which associate file format keywords with file format types;

checking whether a file in an unknown format includes information of a file header;

parsing the file header of the file to acquire a file format keyword from the file header in response to a determination that the file includes the information of the file header, identifying in the relation table a file format type which is associated with the file format keyword, and identifying an application associated with the file using the file format type,

providing a default software recommendation window in a Windows operating system to prompt a user to download an application from the Internet or to select a local application in response to a determination that the file does not include the information of the file header; and

opening the file using the application.

A storage medium of various examples may store computer-executable instructions. The computer executable instructions are executable by a computer to implement a method for processing files in unknown formats which may include:

parsing a file header of a file in an unknown format to acquire a file format keyword from the file header; and

determining, based on the file format keyword, a file format type of the file, and acquiring an application associated with the file according to the file format type.

According to the above technical mechanisms, the file header of a file in an unknown format is parsed to obtain a file format keyword from the file header; based on the file format keyword, a file format type of the file is determined; and an application associated with the file is identified using the file format type. Hence, according to various examples, a software environment for opening the file is determined through file header parsing, thus avoids incorrectly identifying a file format and corresponding application program based on a file suffix. Therefore, the rate of correctly identifying an application program is increased according to various examples.

In addition, according to various examples, after an application program associated with a file is identified, a user may be guided to download and install the application program, and the relation which associates the file in the unknown format with the application program can be written in a registry, thus a relation which associated the file format type with an application can be corrected. As such, various examples can help users open a file properly.

### BRIEF DESCRIPTION OF THE DRAWINGS

FIG. 1 is a schematic diagram illustrating a conventional relation which associates a file suffix with an application in a registry;

FIG. 2 is a schematic diagram illustrating a conventional popup window of a Windows operating system for a file in an unknown format;

FIG. 3 is a flowchart illustrating a method for processing files in unknown formats in accordance with various examples of the present disclosure;

FIG. 4 is a schematic diagram illustrating a file header in a bmp file in accordance with various examples of the present disclosure;

FIG. 5 is a flowchart illustrating a method for processing files in unknown formats in accordance with various examples of the present disclosure; and

FIG. 6 is a structure diagram illustrating an apparatus for processing files in unknown formats in accordance with various examples of the present disclosure.

### DETAILED DESCRIPTION

In order to make the object and technical solution of the present disclosure clearer, a detailed description of the present disclosure is hereinafter given with reference to the attached drawings and embodiments.

In conventional art, when there is a file in an unknown format, a file suffix is acquired, and a registry is read to acquire association information of the file suffix to determine an application capable of opening the file.

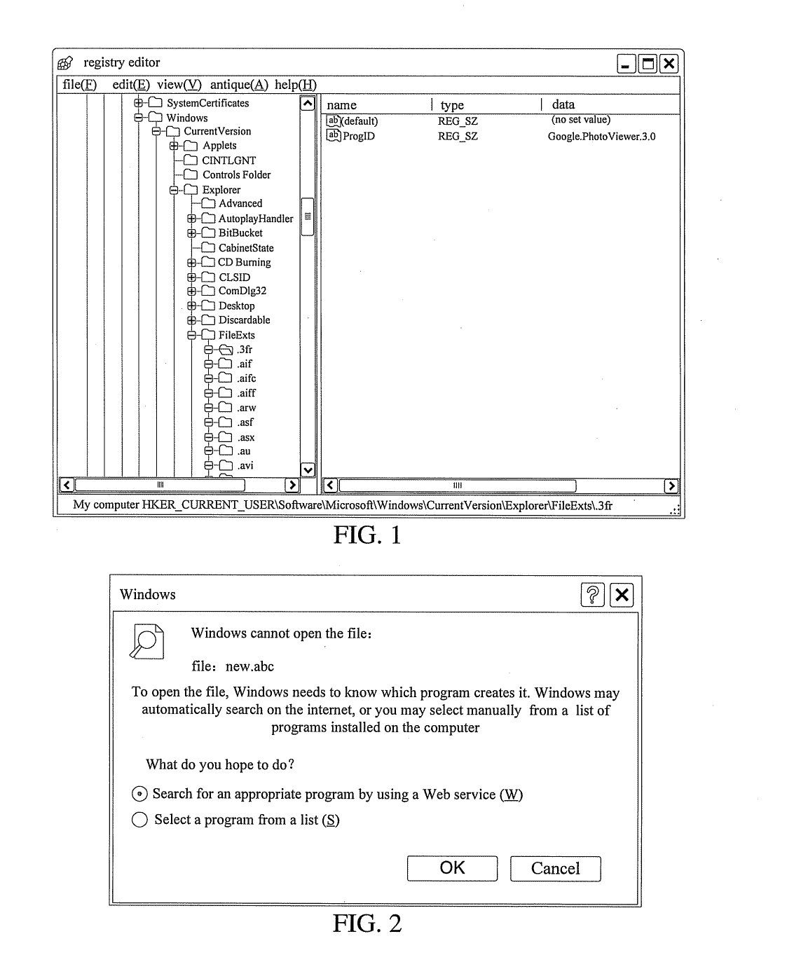

FIG. 1 is a schematic diagram illustrating a conventional relation which associates a file suffix with an application in a registry. As shown in FIG. 1, a registry may store relations which associate file suffixes with applications in specific storage locations. The storage locations may include:

HKEY_CLASSES_ROOT;

HKEY_CURRENT_USER\Software\Microsoft\Windows\Current\Version\Explorer\FileExts;

According to FIG. 1, there is detailed association information of files, and an application associated with a file suffix can be found in the registry.

If an application associated with a file suffix is not installed in a user terminal, however, association information corresponding to the file suffix cannot be found in the registry and the file cannot be opened. In such cases, Windows will process a default routine, i.e., the “unknown software recommendation” program.

FIG. 2 is a schematic diagram illustrating a conventional prompt window of a Windows operating system for an unassociated file. As shown in FIG. 2, the operating system may prompt a user to search for an appropriate application from the Internet or to search for a local application. This process may be problematic for users.

In addition, as analyzed above, above-mentioned process may be incapable of identifying proper applications for files in unknown formats because little information is provided by a file suffix and the same suffix may be associated with a lot of applications. Thus, the rate of correctly identifying applications corresponding to files in unknown formats is low. Furthermore, the file suffix can easily be maliciously tampered to confuse with other file formats, so it is also difficult to identify a proper application for a file in an unknown format.

In order to address at least some of the above-mentioned deficiencies, various examples retrieve information related to the file format directly from a file header of a file in an unknown format and determine an application associated with the file based on the file header.

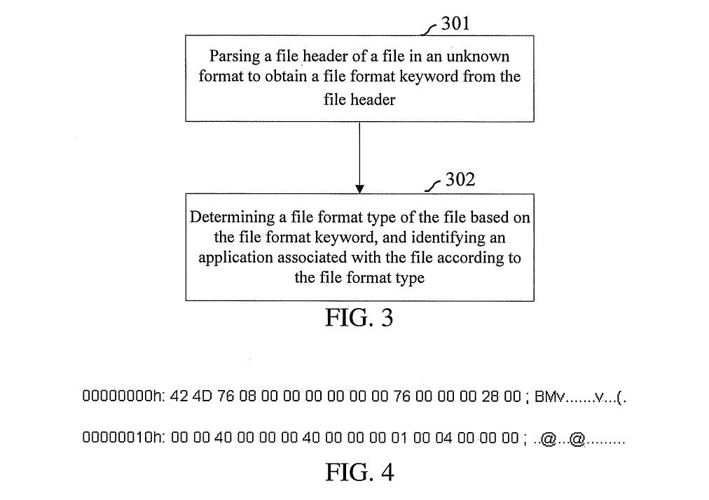

FIG. 3 is a flowchart illustrating a method for processing files in unknown formats in accordance with various examples of the present disclosure.

As shown in FIG. 3, the method may include the following procedures.

At block 301, a file header of a file in an unknown format is parsed to obtain a file format keyword from the file header.

A file is a carrier that describes data. File types vary with different data structures. Each file type has a data format whose definition is usually described in a file header. A file header is usually at the start of a file, and describes some important attributes of the file. For example, FIG. 4 is a schematic diagram illustrating a file header in a bmp file format in accordance with various examples of the present disclosure.

Special fields are generally stored at the start of files of various formats for identifying the file formats. These special fields, also referred to as file format keywords, can be used for identifying the format of a file. By parsing and comparing these special fields with a pre-determined file format, the file type can be determined if the special fields are consistent with the pre-determined file format. After the type of the file is correctly determined, a processing flow may be executed, such as software recommendation, software download, and etc.

A file header often includes hexadecimal special fields. In an example, the hexadecimal special fields may be regarded as the file format keywords and utilized in identifying the type of the file in an unknown format.

In an example, the procedure of parsing a file header of a file in an unknown format to obtain a file format keyword from the file header may include: parsing the file header of the file in the unknown format to obtain a hexadecimal file format keyword from the file header.

Current commonly-used hexadecimal file format keywords include FFD8FF, 89504E47, 47494638, 49492A00, 424D, 41433130, 38425053, 7B5C727466, 3C3F786D6C, 68746D6C3E, 44656C69766572792D646174653A, CFAD12FEC5FD746F, 2142444E, D0CF11E0, 5374616E64617264204A, FF575043, 255044462D312E, AC9EBD8F, E3828596, 504B0304, 52617221, 57415645, 41564920, 2E7261FD, 2E524D46, 000001BA, 000001B3, 6D6F6F76, 3026B2758E66CF11, or D546864, and so on.

A file header may also include text information. The text information may also serve as the file format keyword and be used for identifying a file format. For example, the text information may be included in the file header, and may include auxiliary information such as a company name, a software name, a software version number, etc. In such a case, the text information may be parsed, and the format of the file in an unknown format can be determined according to the auxiliary information such as the company name, the software name, the software version number, etc.

In an example, the area of an file header in a file may be determined according to a file header identifier, and the file format keyword is retrieved from the file header area.

At block 302, a file format type of the file in the unknown format is determined based on the file format keyword, and an application corresponding to the file in the unknown format is obtained according to the file format type.

In this procedure, a list of relations which associate file format types with file format keywords of commonly-used file formats may be established in a database. The list of relations may also include relations which associates the file format types with applications.

In an example, the file format keyword obtained from the file header may be used as the keyword for searching the list of relations, and a file format type associated with the file format keyword is identified in the list. The file format type found is determined as the file format type of the file in the unknown format. Then the list of relations is searched using the file format type to identify an application associated with the file format type, and the application found is determined as the application corresponding to the file in the unknown format.

In an example, the list relation is editable. A file format keyword of a new file format may be added into the list. After an application set as default for opening a file format is modified, the application may also be updated in the list.

After the file format keyword is acquired from the file header, the list may be searched using the file format keyword to determine an application associated with the file format keyword. In an example, the procedure may include: determining a file format type corresponding to the file format keyword by searching the list using the file format keyword, determining an application for opening the file based on the file format type, and associating the application with the file.

In an example, relations associating file types with file format keywords (hexadecimal) of some commonly-used file formats may be as follows:
JPEG (jpg), file header: FFD8FF
PNG (png), file header: 89504E47
GIF (gif), file header: 47494638
TIFF (tif), file header: 49492A00
Windows Bitmap (bmp), file header: 424D
CAD (dwg), file header: 41433130
Adobe Photoshop (psd), file header: 38425053
Rich Text Format (rtf), file header: 7B5C727466
XML (xml), file header: 3C3F786D6C
HTML (html), file header: 68746D6C3E
Email [thorough only] (eml), file header: 44656C69766572792D646174653A
Outlook Express (dbx), file header: CFAD12FEC5FD746F
Outlook (pst), file header: 2142444E
MS Word/Excel (xls.or.doc), file header: DOCF11E0
MS Access (mdb), file header: 5374616E64617264204A
WordPerfect (wpd), file header: FF575043
Adobe Acrobat (pdf), file header: 255044462D312E
Quicken (qdf), file header: AC9EBD8F
Windows Password (pwl), file header: E3828596
ZIP Archive (zip), file header: 504B0304
RAR Archive (rar), file header: 52617221
Wave (way), file header: 57415645
Adobe Acrobat (pdf), file header: 255044462D312E
AVI (avi), file header: 41564920
Real Audio (ram), file header: 2E7261FD
Real Media (rm), file header: 2E524D46
MPEG (mpg), file header: 000001BA
MPEG (mpg), file header: 000001B3
Quicktime (mov), file header: 6D6F6F76
Windows Media (asf), file header: 3026B2758E66CF11
MIDI (mid), file header: 4D546864

For example, in response to a determination that a file format keyword 255044462D312E is included in the file header of the file in an unknown format at block 301, a determination is made that the file format is pdf format developed by Adobe company through searching the list of relations, and a further determination is made that the pdf file format is associated with an Acrobat application developed by Adobe company through searching the list of relations. Therefore, the Acrobat application is activated to open the file.

In an example, alternative to the hexadecimal file format keyword, the file format of the file may be determined based on auxiliary information included in the file header such as the company name, the software name, the software version number, etc. For example, in response to a determination that the file format keywords “Adobe” and “Acrobat” are included in the file header of the file in an unknown format at block 301, it is highly possible that the file is in pdf format and the Acrobat application may be activated to try to open the file.

The method using the hexadecimal file format keyword and the method of using the auxiliary information may be weighted and combined to make the judgment, or used individually.

In an example, after the application associated with the file in an unknown format is determined, a determination may be made as to whether the application associated with the file has been installed locally in the device. In response to a determination that the application has been installed, a relation which associates the file in the unknown format with the application is added into a registry, and the application is activated to open the file. In response to a determination that the application has not been installed, information on a method of downloading the application is pushed to the user. For security considerations, a white list of trusted application may be pre-defined, and the pushing and downloading service is provided only for a file type associated with an application in the white list.

During a downloading process of an application, a server close to the user client is preferable, and the downloading speed may be accelerated using a P2P technique, so that the user is able to download an application in a short time when dealing with a file in an unknown format, thus the rate of successfully finding a matching application is increased.

In an example, differing from the default “unknown application recommendation” of the Windows system, a list of applications commonly-used domestically may be preset at the network side to cater to domestic users' habit. When pushing a download method of an application associated with a file in an unknown format, a domestically commonly-used application in the list is given the priority to be recommended.

In addition, a user's need may be paid continuous attention to by an operating end at the network side, thus there may be frequent changes in the list of recommended applications.

In an example, an operating end at the network side may send the latest list of relations to a client via a configuration file, thus the client is enabled to get information of any update of the list in time.

In an example, the configuration file may include a description field and an application list field. The description field describes attribute information of the configuration file and the application list field describes applications involved in relations included in the configuration file.

In an example, the configuration file may be in the following form:

```
<ext name=”mpeg”>
  <descrip><![CDATA[movie]]></descrip>
    <softlist>
      <soft id=”8” default=”1”/>
      <soft id=”501”/>
      <soft id=”500”/>
  </softlist>
</ext>
```

According to the above example, the description field (descrip) describes attribute information of a movie file, and the application list field (softlist) describes a list of applications associated with the movie file.

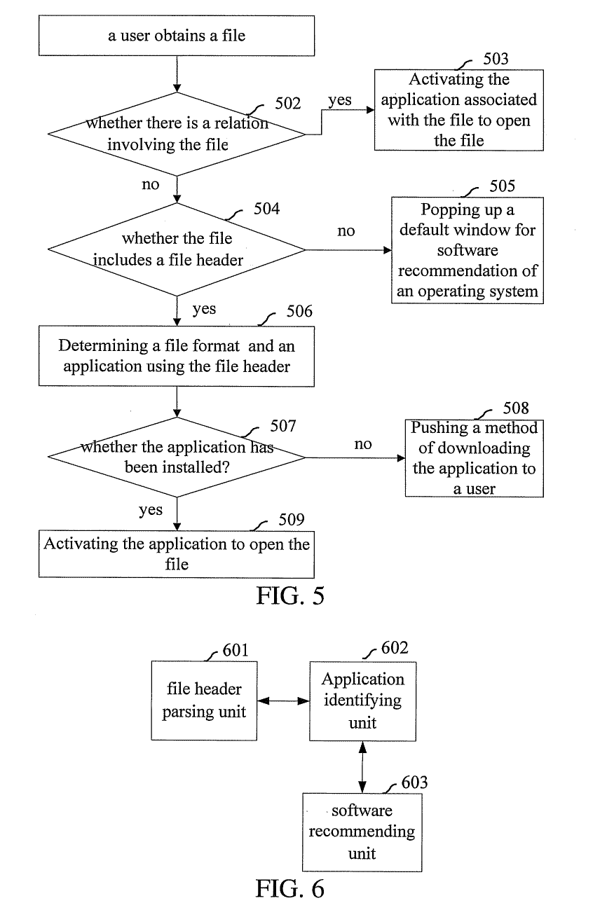

Based on the above detailed description, FIG. 5 is a flowchart illustrating a method for processing files in unknown formats in accordance with various examples of the present disclosure.

As shown in FIG. 5, the method may include the following procedures.

At block 501, a user obtains a file.

At block 502, it is judged whether the file has been associated with an application. If the file has been associated with an application, the procedure in block 503 is performed and this process is terminated. If the file has not been associated with an application, the procedure in block 504 and subsequent procedures are performed.

At block 503, the application associated with the file is activated to open the file.

At block 504, it is judged whether the file includes a file header. If the file includes a file header, the procedure in block 506 and subsequent procedures are performed; otherwise, the procedure in block 505 is performed and the process is terminated.

At block 505, in response to a determination that the file dose not include a file header, a default window for application recommendation in a Windows operating system is popped up to enable a user to download an application which the user regards as associated with the file from the Internet or to select an application locally installed.

At block 506, a file format of the file and an application associated with the file format are determined according to the file header.

A hexadecimal file format keyword extracted from the file header or text information obtained form the file header are used for determining the file format of the file and determine the application associated with the file format.

At block 507, it is judged whether the application has been installed in a local device. If the application has been installed, the procedure in block 509 is performed and the process is terminated. If the application has not been installed, the procedure in block 508 is performed and the process is terminated.

At block 508, a method of downloading the application is pushed to the user.

At block 509, the application which has been installed locally is activated to open the file.

Based on the above detailed analysis, various examples also provide a device for processing files in unknown formats.

FIG. 6 is a schematic diagram illustrating modules of an apparatus for processing files in unknown formats in accordance with various examples of the present disclosure.

As shown in FIG. 6, the apparatus may include a file header parsing unit 601 and an application identifying unit 602.

The file header parsing unit 601 is configured for parsing a file header of a file in an unknown format to obtain a file format keyword from the file header.

The application identifying unit 602 is configured for identifying a file format type of the file in the unknown format based on the file format keyword, and obtaining an application associated with the file according to the file format type.

In an example, the file header parsing unit 601 is configured for parsing the file header of the file in the unknown format, obtaining a hexadecimal file format keyword from the file header. Hexadecimal file format keywords may include FFD8FF, 89504E47, 47494638, 49492A00, 424D, 41433130, 38425053, 7B5C727466, 3C3F786D6C, 68746D6C3E, 44656C69766572792D646174653A, CFAD12FEC5FD746F, 2142444E, DOCF11E0, 5374616E64617264204A, FF575043, 255044462D312E, AC9EBD8F, E3828596, 504B0304, 52617221, 57415645, 41564920, 2E7261FD, 2E524D46, 000001BA, 000001B3, 6D6F6F76, 3026B2758E66CF11, or D546864, and the like.

In an example, the file header parsing unit 601 is configured for parsing the file header of the file in the unknown format to obtain text information, and obtaining the file format keyword according to the text information. The file header parsing unit 601 obtains text information from the file header and obtains a company name, a software name or a software version number from the text information, and searches for an application according to the company name, the software name or the software version number as the file format keyword.

In an example, the file header parsing unit 601 is configured for identifying an file header area in the file using an identifier of the file header, and searching the file header area for the file format keyword.

In an example, the apparatus may also include a software recommending unit 603. The software recommending unit 603 is configured for judging whether the application associated with the file in the unknown format has been installed, and adding a relation which associates the file in the unknown format with the application into a registry in response to a determination that the application has been installed, or pushing a method of downloading the application associated with the file to the user in response to a determination that the application has not been installed.

In an example, the application identifying unit 602 is configured for searching a pre-established list of relations for a file format type corresponding to the file format keyword, determining the file format type found as the file format type of the file; searching the list of relations for an application associated with the file format type according to the file format type determined, and determining an application found as the application associated with the file. The list of relations stores a relation which associates a file format keyword with a file format type and a relation which associates a file format type with an application.

According to various examples of the present disclosure, a file header of a file in an unknown format is parsed first to obtain a file format keyword from the file header, then a file format type of the file is determined based on the file format keyword, and an application associated with the file is identified according to the file format type. By adopting the technical mechanism of the present disclosure, by parsing the file header, the file type is determined and associated software environment is activated, thus avoids misjudgment of the file format resulted from identifying a file format and associated application using a file suffix. Therefore, the rate of successfully identifying matching applications is improved.

According to various examples of the present disclosure, the user may be guided to download and install the application determined or to modify a relation which associates the file format with an improper application. Therefore, the technical mechanism of the present disclosure can help users correctly identify a download address of the appropriate application.

The method and apparatus provided by the present disclosure may be implemented by hardware or computer readable instructions, or may be implemented by combining the hardware and the computer readable instructions. The computer readable instructions used in the present disclosure may be stored in a readable storage medium by multiple processors. The readable storage medium may be a magnetic disk, CD-ROM, DVD, an optical disk, a floppy disk, a magnetic tape, ROM, RAM or other appropriate storage devices. Specific hardware may be instead of at least part of the computer readable instructions, such as a customized integrated circuit, a gate array, FPGA, PLD and a computer having a specific function, and so on.

The present disclosure provides a computer readable storage medium used for storing instructions, enabling the computer to execute said method in the text. Specifically, the system or the device provided by the present disclosure has a storage medium, in which computer readable program code is stored, to realize functions of any one of the examples mentioned above. These systems or devices (or CPU or MPU) are able to read and execute the program code stored in the storage mediums.

In such a case, any one of the examples mentioned above may be implemented by the program code read from the storage medium, so the program code and the storage medium for storing the program code are part of the technical solution.

The storage medium for providing the program code include a floppy disk, a hard disk, a magneto-optical disk, an optical disk (such as CD-ROM, CD-R, CD-RW, DVD-ROM, DVD-RAM, DVD-RW, DVD+RW), a magnetic disk, a flash memory card, ROM, etc. Optionally, the program code may be downloaded from a server computer via a communication network.

It should be noted that, as to the program code executed by the computer, as least part of operations implemented by the program code may be realized by an operating system running on the computer, so as to implement any one of the examples mentioned above in the technical solution, wherein the computer executes the instructions based on the program code.

In addition, the program code of the storage medium is written in a memory, wherein the memory is located in an expansion board inserted into the computer.

The foregoing is merely a preferred example of the present disclosure, but not to limit the protection scope of the present disclosure. Any changes made, variations or equivalent replacements, etc. within the principles of the present disclosure shall be included in the protection scope of the present disclosure.

1. (canceled)

2. The method of claim 6, wherein the parsing a file header of a file in an unknown format to obtain a file format keyword from the file header comprises:
parsing the file header of the file to obtain a hexadecimal file format keyword from the file header.

3. The method of claim 6, wherein the parsing a file header of a file in an unknown format to obtain a file format keyword from the file header comprises:
parsing the file header of the file to obtain text information, and obtaining the file format keyword according to the text information.

4. The method of claim 3, wherein the obtaining the file format keyword according to the text information comprises:
obtaining a company name, a software name or a software version number.

5. The method of claim 6, wherein the parsing a file header of a file to obtain a file format keyword from the file header comprises:
identifying a file header area of the file according to an identifier of the file header; and
searching the file header area for the file format keyword.

6. A method for processing files in unknown formats, comprising:
parsing a file header of a file in an unknown format to obtain a file format keyword from the file header; and
determining a file format type of the file based on the file format keyword, and identifying an application associated with the file according to the file format type;
pre-establishing a relation list which stores a relation which associates the file format keyword with the file format type and a relation which associates the file format type with the application; and
wherein the determining a file format type of the file based on the file format keyword and identifying an application associated with the file comprises:
searching the relation list for a file format type associated with the file format keyword, and determining the file format type found as the file format type of the file; and
searching the relation list for an application associated with the file format type, and determining the application found as the application associated with the file.

7. The method of claim 6, further comprising:
judging whether the application associated with the file has been installed; and
adding a relation which associates the file with the application into a registry in response to a determination that the application has been installed, or pushing a method of downloading the application associated with the file to a user in response to a determination that the application has not been installed.

8. (canceled)

9. The apparatus of claim 13, wherein
the file header parsing unit is configured for parsing the file header of the file to obtain a hexadecimal file format keyword from the file header.

10. The apparatus of claim 13, wherein
the file header parsing unit is configured for parsing the file header of the file in the unknown format to obtain text information, and obtaining the file format keyword according to the text information.

11. The apparatus of claim 10, wherein
the file header parsing unit is configured for parsing the file header of the file to obtain text information, and obtaining a company name, a software name or a software version number from the text information.

12. The apparatus of claim 13, wherein
the file header parsing unit is configured for identifying a file header area of the file using an identifier of the file header, and searching the file header area for the file format keyword.

13. An apparatus for processing files in unknown formats, comprising a file header parsing unit and an application identifying unit, wherein
the file header parsing unit is configured for parsing a file header of a file in an unknown format using a processor to obtain a file format keyword from the file header; and
the application identifying unit is configured for determining a file format type of the file based on the file format keyword using a processor, and identifying an application associated with the file according to the file format type; wherein
the application identifying unit is configured for searching a pre-established relation list for a file format type associated with the file format keyword, and determine the file format type found as the file format type of the file, searching the relation list for an application associated with the file format type, and determining the application found as the application associated with the file;
wherein the relation list stores a relation which associates the file format keyword with the file format type and a relation which associates the file format type with the application.

14. The apparatus of claim 13, further comprising a software recommending unit, wherein
the software recommending unit is configured for judging whether the application associated with the file has been installed using a processor, and adding a relation which associates the file with the application into a registry in response to a determination that the application has been installed, or pushing a method of downloading the application associated with the file to a user in response to a determination that the application has not been installed.

15. A method for processing files in unknown formats, comprising:
pre-establishing a list of relations which associates file format keywords with file format types;
judging whether a file in an unknown format includes a file header;
parsing the file header of the file to obtain a file format keyword from the file header in response to a determination that the file includes a file header, searching the list for a file format type associated with the file format keyword obtained, and identifying an application associated with the file using the file format type of the file, or
popping up a default windowed for software recommendation of a Windows operating system to enable a user to download an application which the user regards to be associated with the file from the Internet or to select an application from locally installed applications; and
opening the file using the application.

16. (canceled)
